(19) United States
(12) Patent Application Publication
(10) Pub. No.: US 2004/0156095 A1
(43) Pub. Date: Aug. 12, 2004

(54) Raman amplifier and optical communication system including the same

(75) Inventors: Tetsufumi Tsuzaki, Yokohama-shi (JP); Shinobu Tamaoki, Yokohama-shi (JP)

Correspondence Address: MCDERMOTT WILL & EMERY LLP, 600 13TH STREET, N.W., WASHINGTON, DC, 20005-3096, US

(73) Assignee: Sumitomo Electric Industries, Ltd.

(21) Appl. No.: 10/772,284

(22) Filed: Feb. 6, 2004

(30) Foreign Application Priority Data
Feb. 7, 2003 (JP) P2003-030791
Dec. 15, 2003 (JP) P2003-417124

(51) Int. Cl. H01S 3/00

(52) U.S. Cl. 359/334

(57) ABSTRACT

The present invention relates to a Raman amplifier and the like which has a structure capable of easily improving the transient response characteristic without depending on the added/dropped signal channels. In the Raman amplifier, a pumping light source supplies forward pumping light of wavelength λₚ₀ to a Raman-amplifying optical fiber. A pumping light source supplies N-channel backward pumping light of wavelengths λₚ₁-λ_{pN} to the Raman-amplifying optical fiber. The wavelength λₚ₀ of the forward pumping light is less than or equal to the shortest wavelength of the channel wavelengths λₚ₁-λ_{pN} of the backward pumping light. In particular, the power of the backward pumping light and the power of the forward pumping light are arranged such that the effective length L_{eff} of the Raman-amplifying optical fiber for the channel wavelengths λₚ₁-λ_{pN} of the backward pumping light becomes longer than the actual length L.

### BACKGROUND OF THE INVENTION

1. Field of the Invention

The present invention relates to a Raman amplifier for Raman-amplifying signal light of a plurality of signal channels having wavelengths different from each ther (multiplexed signal light) and an optical communication system including the Raman amplifier.

2. Background of Related Art

The Raman amplifier is an optical component applied to a Wavelength Division Multiplexing (WDM) optical communication system that transmits multiplexed signal light in which a plurality of signal channels are multiplexed. The Raman amplifier can Raman-amplify the multiplexed signal light propagating through an optical fiber by supplying pumping light to the optical fiber that is an optical amplification medium. Accordingly, the Raman amplifier is widely utilized in the WDM optical communication system in order to compensate for the loss suffered while the multiplexed signal light propagates through optical fiber transmission lines. Further, in the case where an OADM or OXC has been introduced in the WDM optical communication system, there may be a case where the number of channels of the signal light propagating through the optical fiber transmission line changes; the number of channels of the signal light input into the Raman amplifier changes accordingly.

The following documents point out the fact that, when the number of channels of the signal light input into the Raman amplifier fluctuates as described above, a problem occurs in the transient response characteristic of the Raman amplifier. (Document 1) Y. Sugaya, et al., “Suppression method of transient power response of Raman amplifier caused by channel add-drop”, ECOC2002 28^{th} European Conference on Optical Communication, Vol. 1, Sep. 9, 2002. (Document 2) Stuart Gray, “Transient gain dynamics in wide bandwidth discrete Raman amplifiers”, OFC2002 OPTICAL FIBER COMMUNICATION CONFERENCE AN EXHIBIT, Mar. 17-22, 2002, ThR2. That is to say, at the time of channel add/drop, the gain of Raman amplification not only fluctuates but also sometimes undershoots or overshoots with respect to the signal light which is continuously inputted into the Raman amplifier before and after that.

The technique set forth in the above document 1 was intended to solve such a problem in the transient response characteristic of the Raman amplifier as described above. In the technique set forth in the document 1, not only pumping light is supplied to the optical fiber from the back of the optical fiber served as the optical amplification medium (backward pumping light), but also pumping light is supplied to the optical fiber from the front side thereof (forward pumping light). The power of the forward pumping light is controlled in response to the fluctuation in the number of channels of the signal light input into the Raman amplifier, and thereby the transient response characteristic is improved (feedforward control).

### SUMMARY OF THE INVENTION

As a result of examination on the above-mentioned related art, the inventors discovered the following problem. That is, in the above technique set forth in the document 1, depending on the added or dropped signal channels, there is a case where the improvement of the transient response characteristic is insufficient. In other words, only by feedforward control on the forward pumping light like the above-mentioned technique set forth in the document 1, it is impossible to cope with the time-varying of optical parts and LD served as a pumping light source within the Raman amplifier, and thus the output power level of each signal channel cannot be controlled precisely.

The present invention has been proposed to solve the above-mentioned problem. An object of the present invention is to provide a Raman amplifier having such structure that the transient response characteristic is easily improved without depending on the added/dropped signal channels, and an optical communication system including the Raman amplifier.

The Raman amplifier according to the present invention comprises a Raman-amplifying optical fiber, a first pumping light source and a second pumping light source. The Raman-amplifying optical fiber includes an input end into which signal light multiplexed with a plurality of signal channels having different wavelengths is inputted and an output end from which the Raman-amplified signal light is outputted. The first pumping light source supplies backward pumping light, which is multiplexed with a plurality of pumping channels having different wavelengths, to the Raman-amplifying optical fiber through the output end thereof. The second pumping light source supplies forward pumping light, which is multiplexed with one or more pumping channels, into the Raman-amplifying optical fiber through the input end thereof. The number of channels in the forward pumping light is less than the number of channels in the backward pumping light. This is because, when the number of channels in the forward pumping light is greater, the intensity noise (intensity fluctuation) of the forward pumping light affects the signal light propagating in the Raman-amplifying optical fiber. Each pumping channel included in the forward pumping light has a wavelength shorter than the shortest pumping channel wavelength of the backward pumping light.

In particular, in the Raman amplifier according to the present invention, each power of the backward pumping light and the forward pumping light, which is outputted from the first and second pumping light sources respectively, is arranged such that the effective length of the Raman-amplifying optical fiber becomes longer than the actual length with respect to each pumping channel in the backward pumping light. In general, the Raman-amplifying optical fiber applied to the Raman amplifier according to the present invention has a high non-linearity. When light having a high power is inputted into the Raman-amplifying optical fiber, a Stokes light is generated at the longer wavelength side rather than the wavelength of the input light, due to stimulated Raman scattering (SRS). Owing to the Stokes light, it is possible to give a gain to the pumping channel included in the backward pumping light. At this time, when the given gain is larger than the transmission loss of each pumping channel included in the backward pumping light, it is possible to expand the effective length of the Raman-amplifying optical fiber with respect to each pumping channel included in the backward pumping light. Accordingly, the wavelength of the pumping channel included in the forward pumping light is arranged so as to be shorter than the shortest pumping channel wavelength of the backward pumping light.

With the Raman amplifier structured as described above, it is possible that, in an optical communication system including in a photonic network, in which an OADM or OXC is introduced, the transient response characteristic can be improved easily without depending on the added/dropped signal channels.

The Raman amplifier according to the present invention may further comprise an input monitor apparatus and a controller for enabling feedforward control. In this case, the input monitor apparatus is disposed at the input end side of the Raman-amplifying optical fiber and monitors the input power level of each signal channel included in the signal light. The controller controls at least the second pumping light source based on the input power level of each signal channel monitored by the input monitor apparatus such that the output power level of each signal channel is set at a predetermined value.

Here, when the input power level of the signal channels fluctuates in a predetermined pattern without change of the number of channels in the input signal light, the controller may perform feedforward control only on the power of the backward pumping light supplied from the second pumping light source to the Raman-amplifying optical fiber. Here, the term “predetermined pattern” means a state where one or more signal channels fluctuate exceeding a predetermined value. The predetermined value varies depending on the combination. Further, when the number of channels in the input signal light fluctuates, the controller may perform feedforward control on the power of each of the pumping channels involved to Raman amplification of those signal channels whose input power level does not fluctuate exceeding a predetermined value. Furthermore, based on the input power level of a plurality of signal channels included in the signal light, the controller may perform feedforward control on the power of the backward pumping light and the power of the forward pumping light such that the output power level of these signal channels is set at a predetermined value.

Preferably, in the Raman amplifier according to the present invention, the pumping light power of each of the first and second pumping light sources is set in a predetermined relationship with respect to the Raman amplification characeristic of the Raman-amplifying optical fiber such that the Raman amplification gain of each signal channel at the input end of the Raman-amplifying optical fiber is 50% or more, preferably 80% or more of the small signal gain obtained by the same power of the pumping light. Here, the input power level of each signal channel at the input end of the Raman-amplifying optical fiber is equal to the power level that is typically used in an optical communication system to which the Raman amplifier is applied. Further, the term “small signal gain” means unsaturated gain, which is obtained with the same power of pumping light when a signal channel with a small input power level is inputted; it indicates a specific gain in a small signal gain area in which the Raman gain is constant.

The reason why the Raman amplification gain of each signal channel is set to 50% or more, preferably 80% or more of the small signal gain as described above is that use in a saturated state causes overshoot of the transient response. Further, particular setting of the power of pumping light for each of the first and second pumping light sources is made by relatively reducing the power of pumping light at the longer wavelength side (pumping channel side included in the backward pumping light), and at the same time, by increasing the power of pumping light at the shorter wavelength side (pumping channel side included in the forward pumping light).

The Raman amplifier according to the present invention may comprise an optical transmission line (signal delay means) between the input monitor apparatus and the Raman-amplifying optical fiber. The optical transmission line has a length such that the propagation time of the signal light is greater than or equal to the shortest time necessary for controlling the second pumping light source by the controller. Here, it is preferred that the controller has a function of adjusting the time necessary for controlling the second pumping light source. Further, it is preferred that the optical transmission line Raman-amplifies the signal light. For example, the optical transmission line may include an optical fiber doped with a rare earth element.

The Raman amplifier according to the present invention may comprise a dummy signal light supply system for supplying the Raman-amplifying optical fiber with dummy signal light having the same wavelength as the wavelength of one of a plurality of signal channels whose input power level monitored by the input monitor apparatus is less than or equal to a predetermined value. In this case, the controller constitutes part of the dummy signal light supply system.

If a Raman amplifier is subjected to feedback control faster than the response speed, which depends on the length and pumping direction of the Raman-amplifying optical fiber, the feedback is applied faster than the output response, and thereby theoretically resulting in oscillation of the output. Accordingly, the Raman amplifier according to the present invention may comprise such configuration that performs a faster feedforward control as described above to suppress overshoot or undershoot of the transient response, and performs feedback control at a slower period to carry out high precision output control. Thus, by performing a two-step control, it is made simultaneously possible to effectively suppress overshoot or undershoot of the transient response in the Raman amplifier and to perform high precision control of the output.

That is, in order to enable feedforward control and feedback control, the Raman amplifier according to the present invention comprises, as described above, a Raman-amplifying optical fiber, a first pumping light source, a second pumping light source, an input monitor apparatus and a controller, and further an output monitor apparatus disposed at the output end side of the Raman-amplifying optical fiber. The controller controls at least any one of the first and second pumping light sources based on the detection results of the input monitor apparatus and the output monitor apparatus.

In particular, at the time when power fluctuation of the signal light at the input end of the Raman-amplifying optical fiber has been detected, the controller may perform feedforward control on the first pumping light source, and subsequently feedback control on the first pumping light source at a period slower than the time necessary for the signal light to propagate through the Raman-amplifying optical fiber. Also, at the time when power fluctuation of the signal light at the output end of the Raman-amplifying optical fiber has been detected, the controller may perform feedforward control on the second pumping light source, and subsequently feedback control on the second pumping light source at a period slower than the time necessary for the signal light to propagate through the Raman-amplifying optical fiber. Furthermore, at the time when power fluctuation of the signal light at the input end of the Raman-amplifying optical fiber has been detected, the controller may perform feedforward control on the first pumping light source, and at the time when power fluctuation of the signal light at the output end of the Raman-amplifying optical fiber has been detected, the controller may perform feedforward control on the second pumping light source, and subsequently the controller may perform feedback control on each of the first and second pumping light sources at a period slower than the time necessary for the signal light to propagate through the Raman-amplifying optical fiber. It is also possible that, at the time when power fluctuation of the signal light at the input end of the Raman-amplifying optical fiber has been detected, the controller may perform feedforward control on the first pumping light source, and subsequently feedback control on each of the first and second pumping light source at a period slower than the time necessary for the signal light to propagate through the Raman-amplifying optical fiber.

The Raman amplifier for performing feedforward control and feedback control may further comprise an optical transmission line (delay means), which is disposed between the input monitor apparatus and the input end of the Raman-amplifying optical fiber, and has a length such that the propagation time of the signal light corresponds to the time interval from the time when input power fluctuation is detected to the time when the control for the first pumping light source is started.

The optical communication system according to the present invention includes a Raman amplifier having the structure as described above (Raman amplifier according to the present invention). The Raman amplifier is disposed on an optical fiber transmission line through which the signal light multiplexed with a plurality of signal channels propagates, and the signal light is amplified by the Raman amplifier. The optical communication system uses the Raman amplifier having the structure as described above to amplify the signal light. Accordingly, for example, even when the number of channels of the signal light input into the Raman amplifier fluctuates due to an OADM or OXC, the optical communication system can easily improve the transient response characteristic at Raman amplification without depending on the added/dropped signal channels. Consequently, according to the optical communication system, superior quality of signal transmission can be obtained.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram showing the configuration of a first embodiment of a Raman amplifier according to the present invention.

FIG. 2 is a diagram showing the configuration of a Raman amplifier according to a first comparative example.

FIG. 3 is a diagram showing the configuration of a Raman amplifier according to a second comparative example.

FIG. 4 shows power distribution of the signal light in the Raman-amplifying optical fiber of the Raman amplifier according to the first embodiment.

FIG. 5 shows power distribution of the signal light in the Raman-amplifying optical fiber of the Raman amplifier according to the first comparative example.

FIG. 6 shows power distribution of the signal light in the optical fiber of the Raman amplifier according to the second comparative example.

FIG. 7 shows power distribution of pumping light in the Raman-amplifying optical fiber of the Raman amplifier according to the first embodiment.

FIG. 8 shows power distribution of pumping light in the Raman-amplifying optical fiber of the Raman amplifier according to the second comparative example.

FIG. 9 is a graph showing the response characteristic for the output power level of the remaining signal channels in the case where the input of several signal channels is turned on and off in a stepwise manner in the Raman amplifier according to the second comparative example.

FIG. 10 is a graph showing fluctuation of the gain spectrum of the Raman amplifier according to the second comparative example.

FIG. 11 is a graph showing the response of the fluctuation of output signal power level to the fluctuation of pumping power level in the Raman amplifier according to the first comparative example.

FIG. 12 is a graph showing the response of the fluctuation of output signal power level to the fluctuation of pumping power level in the Raman amplifier according to the second comparative example.

FIG. 13 is a diagram showing the configuration of a second embodiment of a Raman amplifier according to the present invention.

FIG. 14 is a diagram showing the configuration of a third embodiment of a Raman amplifier according to the present invention.

FIG. 15 is a diagram showing the configuration of a fourth embodiment of a Raman amplifier according to the present invention.

FIGS. 16A and 16B are graphs showing the response of the output signal to the fluctuation of pumping light, regarding to forward pumping and backward pumping, respectively.

FIGS. 17A and 17B are graphs showing the difference in the response characteristic of the Raman amplifier depending on the control of the pumping light at the time of fluctuation in the number of channels, regarding to forward pumping and backward pumping, respectively.

FIGS. 18A and 18B are graphs showing the temporal fluctuation of the signal light and the pumping light control signal, regarding to forward pumping and backward pumping, respectively.

FIG. 19 is a diagram showing the configuration of a fifth embodiment of a Raman amplifier according to the present invention.

FIG. 20 is a diagram showing the configuration of an optical communication system according to the present invention.

### DETAILED DESCRIPTION OF THE PREFERRED EMBODIMENTS

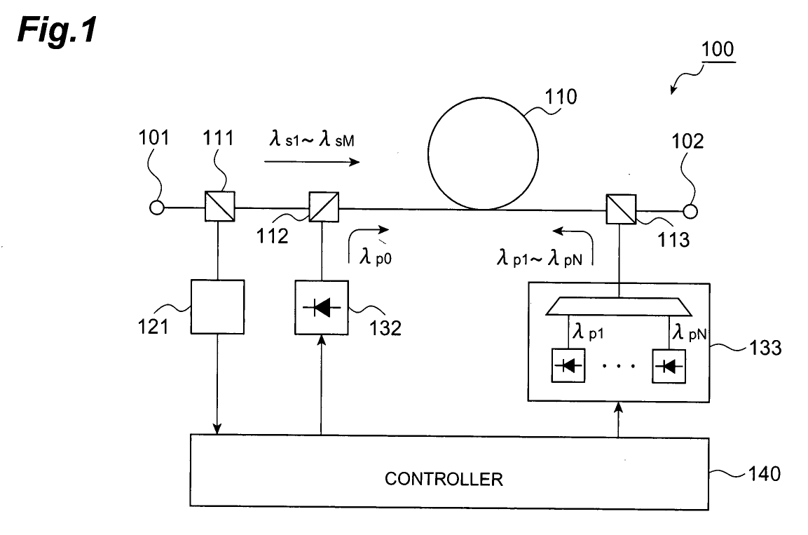

Embodiments of a Raman amplifier and an optical communication system including the same in accordance with the present invention will now be described in detail with reference to FIGS. 1-15, 16A-18B, 19, and 20. In the description of drawings, like elements and parts will be given like reference numerals, and redundant descriptions will be omitted.

(First Embodiment of Raman Amplifier)

First of all, a first embodiment of a Raman amplifier according to the present invention will be described. FIG. 1 is a diagram showing the configuration of the first embodiment of a Raman amplifier according to the present invention. The Raman amplifier 100 shown in FIG. 1 comprises an optical coupler 111, an optical coupler 112, a Raman-amplifying optical fiber 110 and an optical coupler 113 being disposed in that order from a light input end 101 to a light output end 102. The Raman amplifier 100 further comprises a monitor 121 constituting part of an input monitor apparatus connected to the optical coupler 111, a pumping light source 132 (second pumping light source for supplying forward pumping light) connected to the optical coupler 112, a pumping light source 133 (first pumping light source for supplying backward pumping light) connected to the optical coupler 113, and a controller 140.

The optical coupler 111 branches off part of signal light multiplexed with signal channels of wavelengths λₛ₁-λ_{sM} (M is an integer greater than or equal to 2) input through the light input end 101. The branched part is outputted to the monitor 121, and the rest of the signal light is outputted to the optical coupler 112. The monitor 121 receives signal channels of wavelengths λₛ₁-λ_{sM} branched by the optical coupler 111 to monitor the input power level of each signal channel.

The pumping light source 132 includes a pumping LD for outputting forward pumping light including a pumping channel of wavelength λₚ₀, and outputs the forward pumping light to the optical coupler 112. The optical coupler 112 outputs, to the optical fiber 110, signal light including signal channels λₛ₁-λ_{sM} which has arrived from the optical coupler 111, and supplies the Raman-amplifying optical fiber 110 with the forward pumping light of wavelength λₚ₀ which has been output from the pumping light source 132.

The pumping light source 133 includes pumping LDs for outputting light of wavelengths λₚ₁-λ_{pN} (N is an integer greater than or equal to 2) and a multiplexer for multiplexing these beams of output light having different wavelengths, and outputs, to the optical coupler 113, backward pumping light in which N pumping channels corresponding to respective output wavelengths from the pumping LDs are multiplexed. The optical coupler 113 outputs, to the output end 102, signal light including signal channels λₛ₁-λ_{sM} which has arrived from the Raman-amplifying optical fiber 110, and supplies the Raman-amplifying optical fiber 110 with the backward pumping light of N pumping channels λₚ₁-λ_{pN} which has been output from the pumping light source 133.

Here, the wavelength of the pumping channels included in the pumping light supplied to the Raman-amplifying optical fiber 110 has a relationship expressed by the following formula (1).

λₚ₀<λₚ₁<λₚ₂< . . . <λ_{pN} (1)

That is to say, the wavelength λₚ₀ of the pumping channel included in the forward pumping light is less than or equal to the shortest wavelength of the wavelengths λₚ₁-λ_{pN} of the N pumping channels included in the backward pumping light.

Also, the power of the pumping light (including pumping channels of wavelengths λₚ₀-λ_{pN}) supplied from the pumping light sources 132 and 133 to the Raman-amplifying optical fiber 110, is arranged such that the effective length L_{eff} of the Raman-amplifying optical fiber 110 for the N pumping channels λₚ₁-λ_{pN} included in the backward pumping light is longer than the actual length L of the Raman-amplifying optical fiber 110. Here, the effective length L_{eff} is expressed by the following formula (2).

L_{eff}=[1−exp(αL)]/α (2)

Here, α denotes amplification loss of the Raman-amplifying optical fiber 110. In the case of amplification, the value of a is greater than or equal to 1.

The controller 140 detects power fluctuation and channel add/drop in each signal channel included in the signal light which is inputted through the light input end 101, based on the input power level of each signal channel monitored by the monitor 121. The controller 140 then controls at least the power of the pumping channel λₚ₀ included in the forward pumping light supplied from the pumping light source 132 to the Raman-amplifying optical fiber 110, to a predetermined value based on the detection result such that the output power level of each signal channel is set at a predetermined value. Further, the controller 140 also controls each power of the pumping channels λₚ₁-λ_{pN} included in the backward pumping light supplied from the pumping light source 133 to the Raman-amplifying optical fiber 110, to a predetermined value. The Raman amplifier 100 structured as described above can easily improve the transient response characteristic without depending on the added/dropped signal channels.

Preferably, when the input power level of any of the signal channels fluctuates in a predetermined pattern without fluctuation in the number of channels in the input signal light, the controller 140 performs feedforward control only on the power of the backward pumping light supplied from the pumping light source 133 to the optical fiber 110. Here, the term “predetermined pattern” means that one or more pumping channels fluctuate exceeding a predetermined value. The predetermined value varies depending on the combination. When the number of channels in the input signal light fluctuates, the controller 140 may perform feedforward control such that the power of the pumping channel involved to Raman amplification of those signal channels whose input power level does not fluctuate exceeding the predetermined value is set at a predetermined value, respectively. The controller 140 may perform feedforward control on the power of the forward pumping light supplied from the pumping light source 132 to the Raman-amplifying optical fiber 110, and the power of the backward pumping light supplied from the pumping light source 133 to the Raman-amplifying optical fiber 110, based on the input power level of each signal channel included in the input signal light such that the output power level of these signal channels is set at a predetermined value.

The relationship between the Raman amplification characteristic of the Raman-amplifying optical fiber 110 and the power of the forward pumping light and the power of the backward pumping light which are output from the pumping light sources 132 and 133, respectively, is arranged to be a predetermined relationship such that the Raman amplification gain with respect to each signal channel at the input end of the Raman-amplifying optical fiber 110 is equal to 50% or more, preferably 80% or more of a small signal gain obtained by the same power of pumping light. Here, the input power level of each signal channel at the input end of the Raman-amplifying optical fiber means a power level that is typically used in an optical communication system to which the Raman amplifier 100 is applied. Also, the term “small signal gain” means unsaturated gain obtained by the same power of pumping light when a signal channel of a small input power level is inputted, which is a specific gain in a small signal gain area where the input power level of the signal channels is small and the Raman gain is constant.

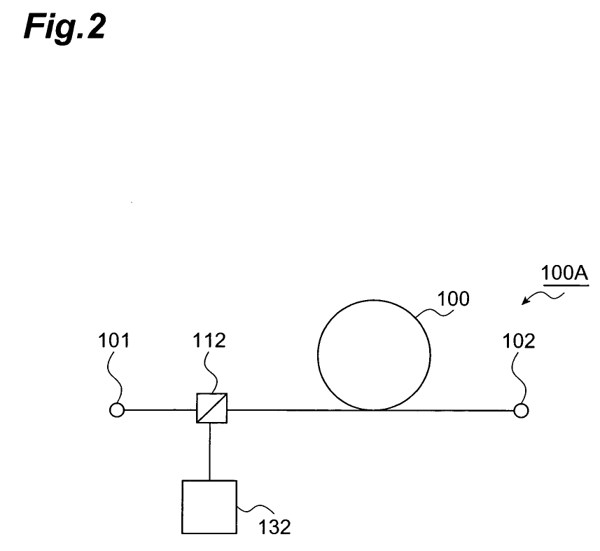

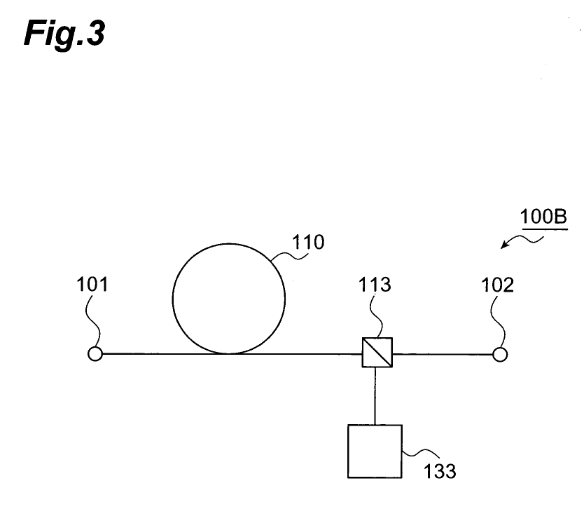

Next, in comparison with first and second comparative examples, the operation and effect of the Raman amplifier 100 according to the first embodiment will be described. FIG. 2 is a diagram showing the configuration of a Raman amplifier 100A of the first comparative example. FIG. 3 is a diagram showing the configuration of a Raman amplifier 100B of the second comparative example.

In the Raman amplifier 100A of the first comparative example, the pumping light output from the pumping light source 132 is supplied to the Raman-amplifying optical fiber 100 only from the front side (input end) of the Raman-amplifying optical fiber 100 through the optical coupler 112 (forward pumping). On the other hand, in the Raman amplifier 100B of the second comparative example, the pumping light output from the pumping light source 133 is supplied to the Raman-amplifying optical fiber 100 only from the backside (output end) of the Raman-amplifying optical fiber 100 through the optical coupler 113.

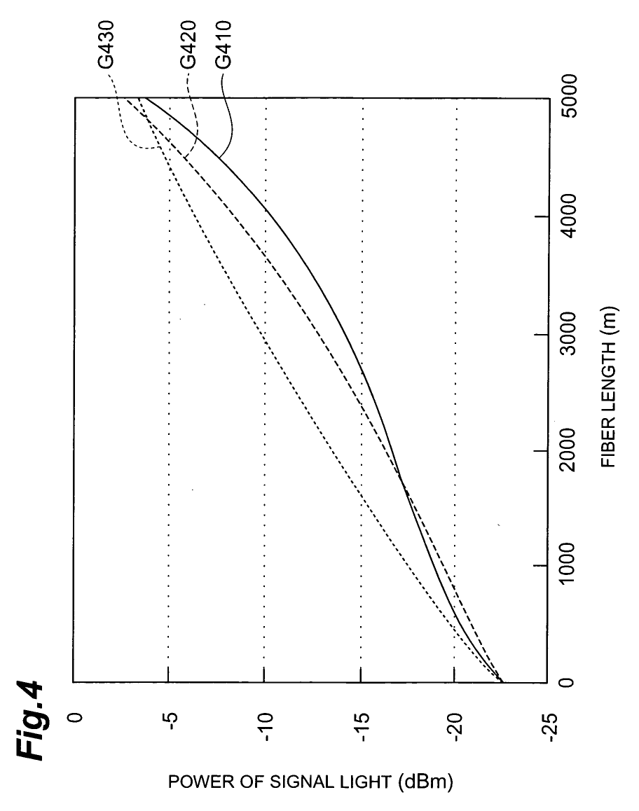

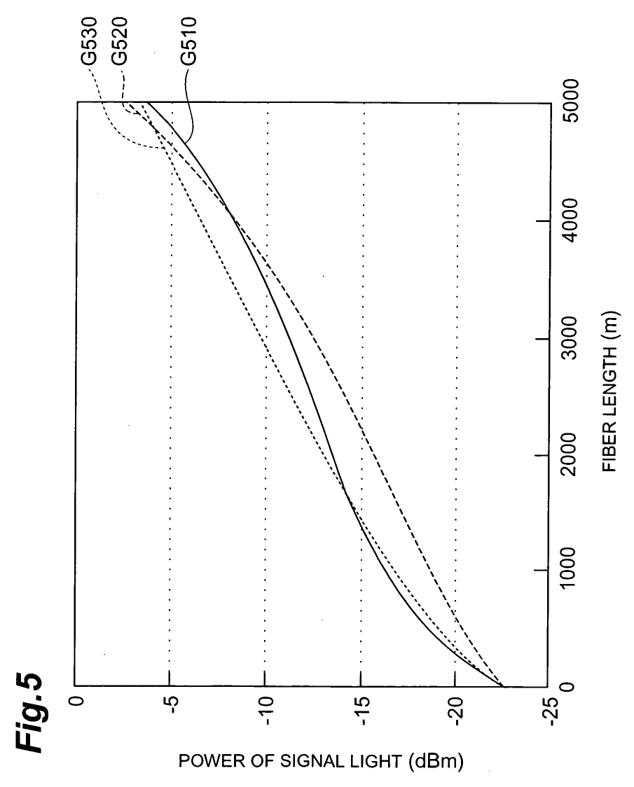

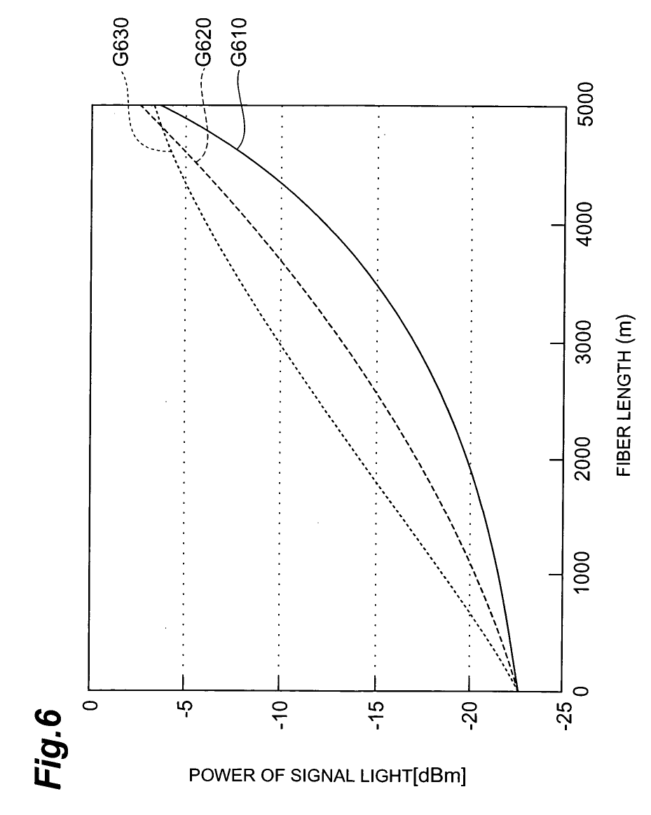

FIG. 4 shows power distribution of the signal light in the Raman-amplifying optical fiber 110 of the Raman amplifier 100 according to the first embodiment. FIG. 5 shows power distribution of the signal light in the optical fiber 110 of the Raman amplifier 100A of the first comparative example. FIG. 6 shows power distribution of the signal light in the optical fiber 110 of the Raman amplifier 100B of the second comparative example. In these FIGS. 4-6, the abscissa indicates fiber length of the Raman-amplifying optical fiber 110. Further, in FIGS. 4-6, graphs G410, G510 and G610 show power distribution of a signal channel having a wavelength of 1530 nm, respectively. Graphs G420, G520 and G620 show power distribution of a signal channel having a wavelength of 1570 nm, respectively. Graphs G430, G530 and G630 show power distribution of a signal channel having a wavelength of 1610 nm, respectively.

Comparing these FIGS. 4-6 to each other, it is understood that the wavelength dependence of the signal light power distribution in the Raman-amplifying optical fiber 110 is smaller in the case of forward pumping (FIGS. 2 and 5) and two-way pumping (FIGS. 1 and 4) as compared to the case of the backward pumping (FIGS. 3 and 6).

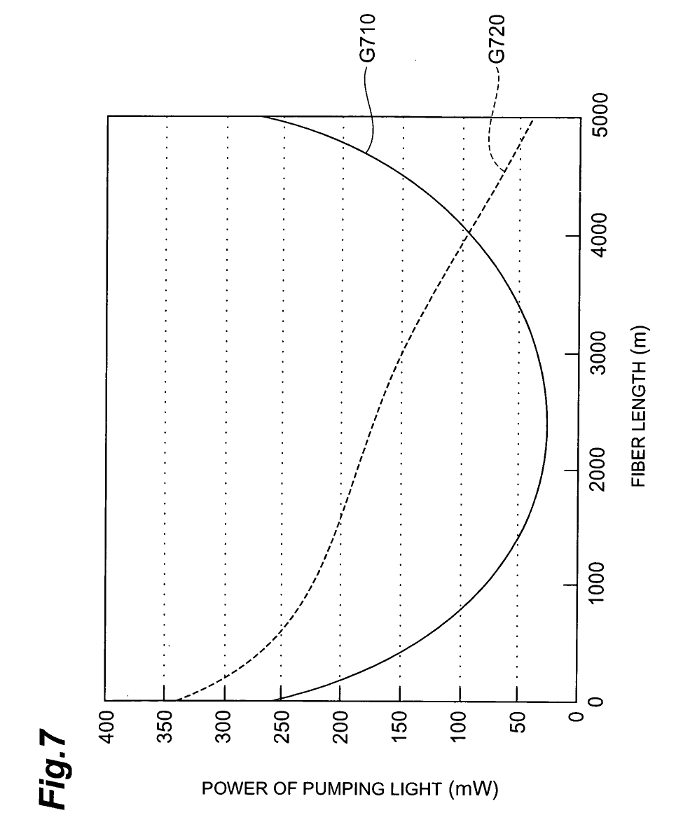

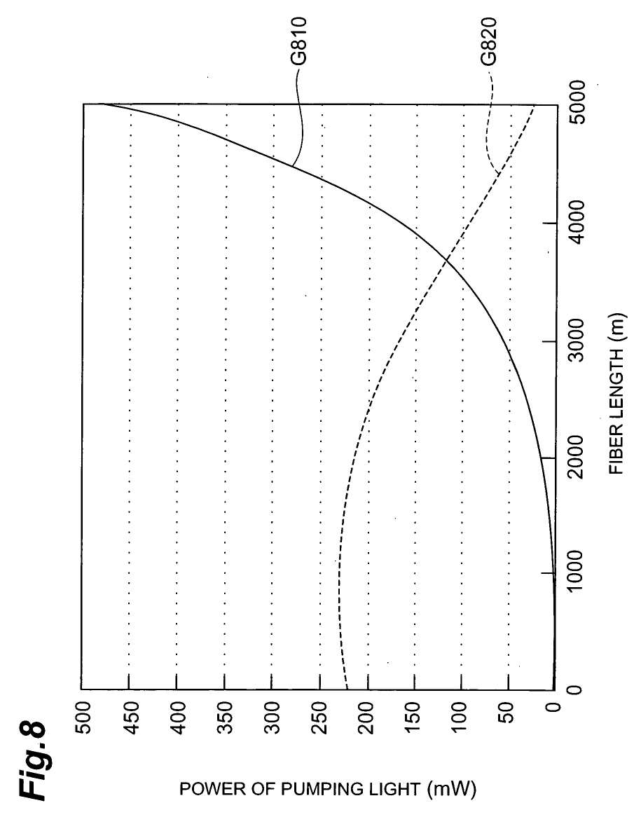

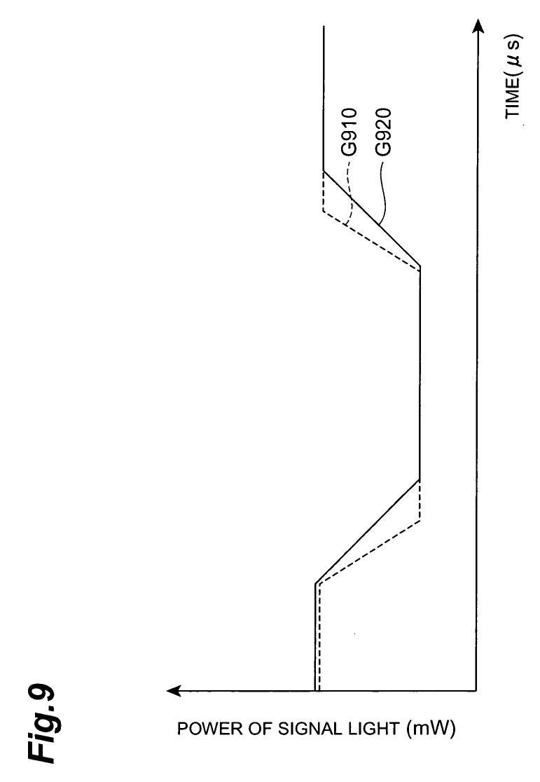

FIG. 7 shows power distribution of pumping light in the optical fiber 110 of the Raman amplifier 100 in accordance with the first embodiment. FIG. 8 shows power distribution of pumping light in the optical fiber 110 of the Raman amplifier 100B of the second comparative example. FIG. 9 is graph showing the response characteristic of the output power level of the remaining signal channels in the case where the input of several signal channels is turned on and off in a stepwise manner in the Raman amplifier 100B of the second comparative example. In FIG. 7, graph G710 shows power distribution of pumping light in the case when the pumping light having a wavelength of 1430 nm is supplied to the Raman-amplifying optical fiber 110 from both sides. Graph G720 shows power distribution of pumping light in the case when the pumping light having a wavelength of 1510 nm is supplied to the Raman-amplifying optical fiber 110 from the front side. In FIG. 8, graph G810 shows power distribution of pumping light in the case when the pumping light having a wavelength of 1430 nm is supplied to the Raman-amplifying optical fiber 110 from the back side. Graph G820 shows power distribution of pumping light in the case when the pumping light having a wavelength of 1510 nm is supplied to the Raman-amplifying optical fiber 110 from the front side. Further, in FIG. 9, graph G910 shows the response characteristic of the signal having a wavelength of 1530 nm. Graph G920 shows the response characteristic of the signal light having a wavelength of 1610 nm. In the case of backward pumping (FIGS. 3 and 8), it is understood that, compared to the pumping light at the shorter wavelength side (1430 nm), the pumping light at the longer wavelength side (1510 nm) has power to a larger extent in the longitudinal direction of the optical fiber 110, and directly contributes to Raman amplification of the signal light in full length of the Raman-amplifying optical fiber 110. The length that directly contributes to the amplification is approximated by the effective length L_{eff} expressed by the above formula (2). In the case of backward pumping, since a shorter wavelength leads to a shorter effective length L_{eff}, the response speed is faster as shown in FIG. 9. Thus, in this embodiment, by supplying pumping light of shorter wavelength to the Raman-amplifying optical fiber 110 through the front side thereof, the difference in the effective length due to different wavelengths is suppressed and the wavelength dependence of the response speed is reduced; thereby the control is simplified.

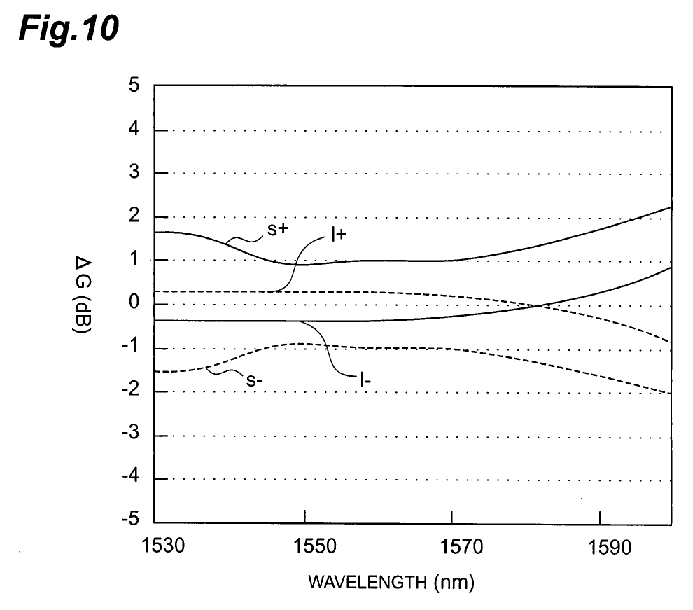

FIG. 10 is a graph showing the fluctuation of gain spectrum of the Raman amplifier 100B of the second comparative example. The fluctuation of gain spectrum is calculated assuming that the wavelength of the pumping channel is 1430 nm, 1445 nm, 1460 nm, 1475 nm, 1490 nm and 1510 nm; the signal wavelength band is 1530 nm-1610 nm; and the average gain of each signal channel is 18 dB. In FIG. 10, the fluctuation of gain spectrum ΔG is shown in the following cases respectively. That is, graph s+shows the case where the power of pumping light of the shortest wavelength 1430 nm is increased by 1 dB; graph s− shows the case where the power of pumping light of the shortest wavelength 1430 nm is decreased by 1 dB; graph 1+shows the case where the power of pumping light of the longest wavelength 1510 nm is increased by 1 dB; graph l− shows the case where the power of pumping light of the longest wavelength 1510 nm is decreased by 1 dB. As demonstrated in FIG. 10, when Raman amplification is carried out in a plurality of pumping channels, the wavelength of the shorter pumping channel gives larger influence to the entire gain. Accordingly, when controlling the output power level of each signal channel included in the signal light to a predetermined value, not by adjusting the power of the pumping channel that directly contribute to the amplification of the signal channels of a specific wavelength, but by controlling the power of the pumping channels at the shorter wavelength side, it is possible to simplify the control without allowing the gain deviation to become too large.

When the power level fluctuation of the input signal light is caused by the change of the number of channels, by controlling only the power of those pumping channels that directly contribute to the amplification of the signal channels having a specific wavelength, to a predetermined value, power consumption can be reduced.

Further, by setting the state of operation of the Raman amplifier near to the state of small signal gain obtained by the same power of pumping light, the power level fluctuation of the output signal light caused by the change the number of channels of the input signal light can be reduced.

Furthermore, by setting the state of operation of the Raman amplifier far from the state of small signal gain obtained by the same power of pumping light, it can be operated in a direction such that the power level of the output signal light is kept constant with respect to the power level fluctuation of the output signal light caused by the power level fluctuation of the input signal light without controlling the power of pumping light.

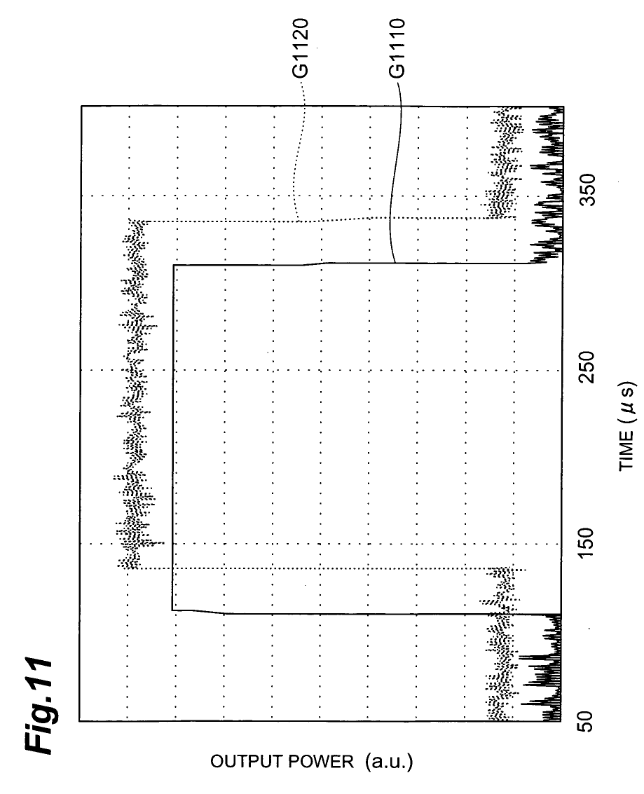

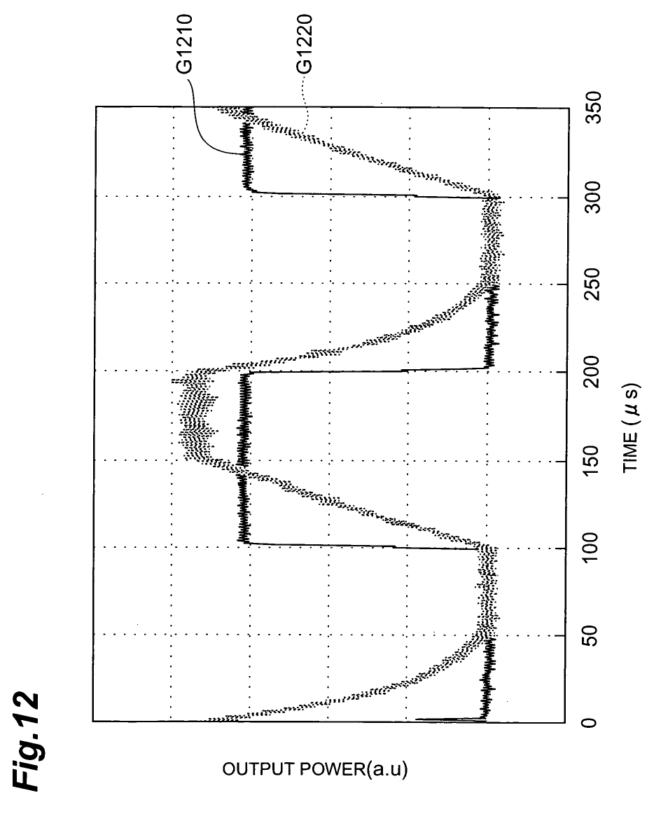

FIG. 11 is a graph showing the response of the power level fluctuation of output signal light to the power level fluctuation of pumping light in the Raman amplifier 110A of the first comparative example. FIG. 12 is a graph showing the response of the power level fluctuation of output signal light to the power level fluctuation of pumping light in the Raman amplifier 110B of the second comparative example. In FIG. 11, graph G1110 represents the power level of the supplied pumping light, and G1120 represents the power level of the output signal light. Also, in FIG. 12, graph G1210 represents the power level of the supplied pumping light, and graph G1220 represents the power level of the output signal light. As demonstrated in FIGS. 11 and 12, the Raman amplifier 110A of the first comparative example in which forward pumping is carried out is different from the Raman amplifier 110B of the first comparative example in which backward pumping is carried out in their response speed. The time necessary for the power level of the output signal light to reach a predetermined value is longer in the case of backward pumping. Accordingly, it is preferred to interpose an optical transmission line (delay fiber) as a delay means between the optical coupler 111 and the optical fiber 110 as described below in the second embodiment.

(Second Embodiment of Raman Amplifier)

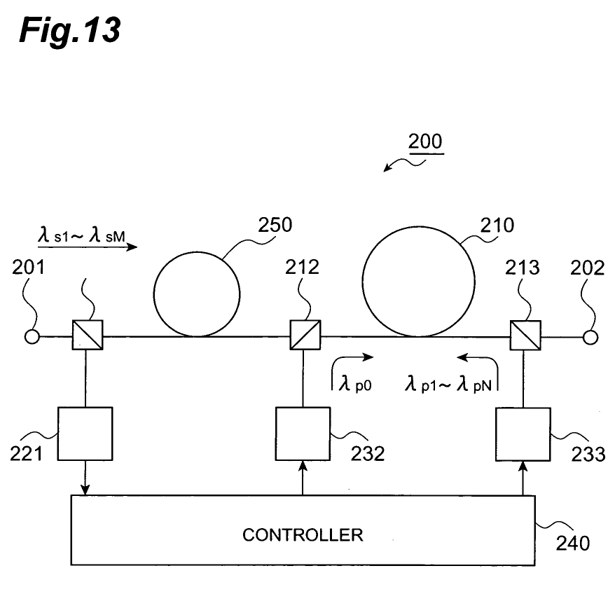

FIG. 13 is a diagram showing the configuration of a second embodiment of a Raman amplifier according to the present invention. The Raman amplifier 200 shown in FIG. 13 comprises an optical coupler 211, a delay fiber (optical transmission line) 250, an optical coupler 212, a Raman-amplifying optical fiber 210 and an optical coupler 213 being disposed in that order from a light input end 201 to a light output end 202. The Raman amplifier 200 further comprises a monitor 221 constituting part of an input monitor apparatus connected to the optical coupler 211, a pumping light source 232 (second pumping light source for supplying forward pumping light) connected to the optical coupler 212, a pumping light source 233 (first pumping light source for supplying backward pumping light) connected to the optical coupler 213, and a controller 240.

The optical coupler 211 branches off part of signal light multiplexed with signal channels of wavelengths λₛ₁-λ_{sM} (M is an integer greater than or equal to 2) input through the light input end 201. The branched part is outputted to the monitor 221, and the rest of the signal light is outputted to the delay fiber 250. The monitor 221 receives the signal light including signal channels λₛ₁-λ_{sM} branched by the optical coupler 211 to monitor the input power level of each signal channel.

The delay fiber 250 is disposed between the optical coupler 211 and the optical coupler 212. The delay fiber 250 receives the signal light which has been output from the optical coupler 211, and transmits the signal light to the optical coupler 212.

The pumping light source 232 has the same structure as that of the pumping light source 132 in the first embodiment, and outputs forward pumping light including a pumping channel of wavelength λₚ₀ to the optical coupler 212. The optical coupler 212 outputs, to the Raman-amplifying optical fiber 210, signal light including signal channels λₛ₁-λ_{sM} which has arrived from the delay fiber 250, and supplies the Raman-amplifying optical fiber 210 with the forward pumping light including the pumping channel λₚ₀ which has been output from the pumping light source 232.

The pumping light source 233 has the same structure as that of the pumping light source 133 in the first embodiment. The pumping light source 233 outputs backward pumping light multiplexed with N pumping channels of wavelengths λₚ₁-λ_{pN} (N is an integer greater than or equal to 2) to the optical coupler 213. The optical coupler 213 outputs, to the light output end 202, signal light including signal channels λₛ₁-λ_{sM} which has arrived from the Raman-amplifying optical fiber 210, and supplies the Raman-amplifying optical fiber 210 with the backward pumping light including N pumping channels λₚ₁-λ_{pN} which has been output from the pumping light source 233.

Here, the wavelength of each pumping channel included in the forward pumping light and the backward pumping light has the relationship expressed by the above formula (1). That is, the pumping channel λₚ₀ included in the forward pumping light has a wavelength less than or equal to the shortest wavelength of the N pumping channels λₚ₁-λ_{pN}, which can be included in the backward pumping light.

Also, the power of the pumping light (including pumping channels of wavelength λₚ₀-λ_{pN}) supplied from the pumping light sources 232 and 233 to the Raman-amplifying optical fiber 210, is arranged such that the effective length L_{eff} of the Raman-amplifying optical fiber 210 for the N pumping channels λₚ₁-λ_{pN} included in the backward pumping light is longer than the actual length L of the Raman-amplifying optical fiber 210.

The controller 240 detects power fluctuation and channel add/drop in each signal channel included in the signal light which is inputted through the light input end 201, based on the input power level of each signal channel monitored by the monitor 221. The controller 240 then controls at least the power of the pumping channel λₚ₀ included in the forward pumping light supplied from the pumping light source 232 to the Raman-amplifying optical fiber 210, to a predetermined value based on the detection result such that the output power level of each signal channel is set at a predetermined value. Further, the controller 240 also controls the power of each of the pumping channels λₚ₁-λ_{pN} included in the backward pumping light supplied from the pumping light source 233 to the Raman-amplifying optical fiber 210, to a predetermined value. The Raman amplifier 200 structured as described above can easily improve the transient response characteristic without depending on added/dropped signal channels.

In particular, the Raman amplifier 200 in accordance with the second embodiment comprises a delay fiber 250 at the signal input end side of the Raman-amplifying optical fiber 210. The delay fiber 250 has a length such that the time necessary for the signal light to propagate through the delay fiber 250 is greater than or equal to the shortest time necessary for controlling the pumping light source 232 by the controller 240. By interposing the delay fiber 250 having a length as described above, it is possible to eliminate the problem due to the delay of control, which is peculiar to the Raman amplifier. Preferably, the controller 240 is provided with a function of adjusting the time necessary for controlling the pumping light source 232.

Preferably, the delay fiber 250 is also supplied with Raman-amplifying pumping light to Raman-amplify the signal light. To amplify the signal light, the delay fiber 250 may include an optical fiber doped with rare earth element. In these cases, the Raman amplifier 200 can achieve a high gain.

(Third Embodiment of Raman Amplifier)

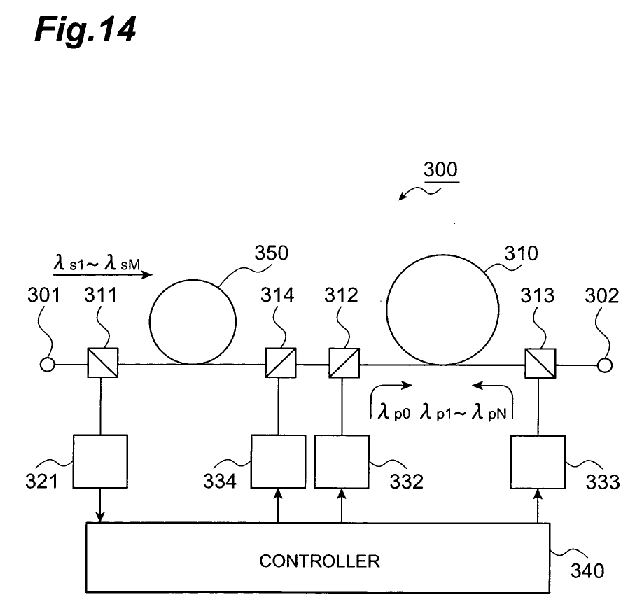

FIG. 14 is a diagram showing the configuration of a third embodiment of a Raman amplifier according to the present invention. The Raman amplifier 300 shown in FIG. 14 comprises an optical coupler 311, a delay fiber (optical transmission line) 350, an optical coupler 314, an optical coupler 312, an Raman-amplifying optical fiber 310 and an optical coupler 313 being disposed in that order from a light input end 301 to a light output end 302. The Raman amplifier 300 further comprises a monitor 321 constituting part of an input monitor apparatus connected to the optical coupler 311, a pumping light source 332 (second pumping light source for supplying forward pumping light) connected to the optical coupler 312, a pumping light source 333 (first pumping light source for supplying backward pumping light) connected to the optical coupler 313, a dummy signal light source 334 connected to the optical coupler 314, and a controller 340.

The optical coupler 311 branches off part of signal light multiplexed with signal channels of wavelengths λₛ₁-λ_{sM} (M is an integer greater than or equal to 2) input through the light input end 301. The branched part is outputted to the monitor 321, and the rest of the signal light is outputted to the delay fiber 350. The monitor 321 receives the signal light including signal channels λₛ₁-λ_{sM} branched by the optical coupler 311 to monitor the input power level of each signal channel.

The delay fiber 350 is an optical waveguide disposed between the optical coupler 311 and the optical coupler 314. The delay fiber 350 receives the signal light which has been output from the optical coupler 311, and transmits the signal light to the optical coupler 314.

The dummy signal light source 334 controls the power of each of the dummy signal channels having wavelengths λₛ₁-λ_{sM}, and outputs dummy signal light multiplexed with these dummy signal channels. The optical coupler 314 outputs, to the optical coupler 312, the signal light which has arrived from the delay fiber 350, and outputs, to the optical coupler 312, the dummy signal light which has arrived from the dummy signal light source 334.

The pumping light source 332 has the same structure as that of the pumping light source 132 in the first embodiment, and outputs forward pumping light including a pumping channel of wavelength λₚ₀ to the optical coupler 312. The optical coupler 312 outputs, to the Raman-amplifying optical fiber 310, the signal light and the dummy signal light which have arrived from the optical coupler 314, and supplies the Raman-amplifying optical fiber 310 with the forward pumping light including the pumping channel λₚ₀ output from the pumping light source 332.

The pumping light source 333 has the same structure as that of the pumping light source 133 in the first embodiment, and outputs backward pumping light multiplexed with N pumping channels of wavelengths λₚ₁-λ_{pN} (N is an integer greater than or equal to 2) to the optical coupler 313. The optical coupler 313 outputs, to the light output end 302, the signal light and the dummy signal light which have arrived from the optical fiber 310, and supplies the Raman-amplifying optical fiber 310 with the backward pumping light including N pumping channels λₚ₁-λ_{pN} which has been output from the pumping light source 333.

Here, the wavelength of each pumping channel included in the forward pumping light and the backward pumping light has the relationship expressed by the above formula (1). That is, the pumping channel λₚ₀ included in the forward pumping light has a wavelength less than or equal to the shortest wavelength of the N pumping channels λₚ₁-λ_{pN} included in the backward pumping light.

Also, the power of the pumping light (including pumping channels of wavelengths λₚ₀-λ_{pN}) supplied from the pumping light sources 332 and 333 to the Raman-amplifying optical fiber 310, is arranged such that the effective length L_{eff} of the Raman-amplifying optical fiber 310 for the N pumping channels λₚ₁-λ_{pN} included in the backward pumping light is longer than the actual length L of the Raman-amplifying optical fiber 310.

The controller 340 detects power fluctuation and channel add/drop in each signal channel included in the signal light which is inputted through the light input end 301, based on the input power level of each signal channel monitored by the monitor 321. The controller 340 then controls at least the power of the forward pumping light including the pumping channel Apo supplied from the pumping light sources 332 to the Raman-amplifying optical fiber 310, to a predetermined value based on the detection result such that the output power level of each signal channel is set at a predetermined value. Preferably, the controller 340 also controls the power of the backward pumping light including the pumping channels λₚ₁-λ_{pN} supplied from the pumping light source 333 to the Raman-amplifying optical fiber 310, to a predetermined value. The Raman amplifier 300 structured as described above can easily improve the transient response characteristic without depending on added/dropped signal channels.

In particular, based on the input power level of each signal channel monitored by the monitor 321, the Raman amplifier 300 in accordance with the third embodiment supplies the Raman-amplifying optical fiber 310 with dummy signal light having the same wavelength as that of a signal channel whose monitored input power level is less than or equal to a predetermined value. Consequently, the transient response characteristic can be further improved.

(Fourth Embodiment of Raman Amplifier)

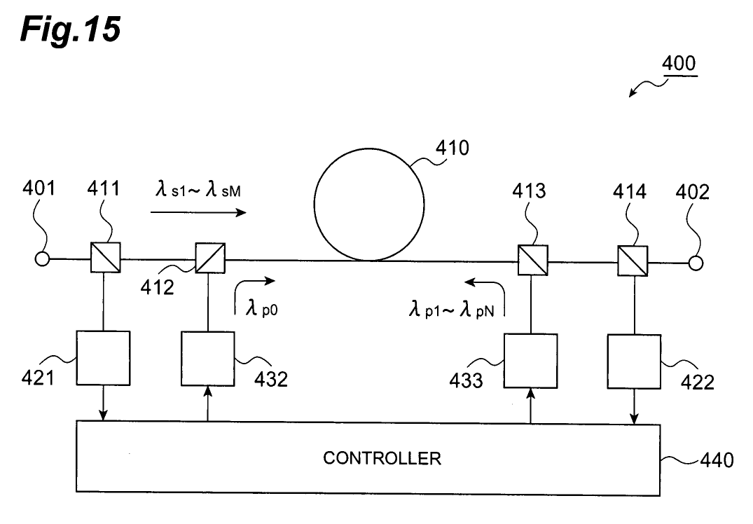

FIG. 15 is a diagram showing the configuration of a fourth embodiment of a Raman amplifier according to the present invention. The Raman amplifier 400 shown in FIG. 15 has such structure that not only feedforward control but also feedback control can be performed. That is, the Raman amplifier 400 comprises an optical coupler 411, an optical coupler 412, a Raman-amplifying optical fiber 410, an optical coupler 413 and an optical coupler 414 being disposed in that order from a light input end 401 to a light output end 402. The Raman amplifier 400 further comprises a monitor 421 constituting part of an input monitor apparatus connected to the optical coupler 411, a pumping light source 432 (second pumping light source for supplying forward pumping light) connected to the optical coupler 412, a pumping light source 433 (first pumping light source for supplying backward pumping light) connected to the optical coupler 413, a monitor 422 constituting part of an output monitor apparatus connected to the optical coupler 414, and a controller 440.

The optical coupler 411 branches off part of signal light multiplexed with signal channels of wavelengths λₛ₁-λ_{sM} (M is an integer greater than or equal to 2) input through the light input end 401. The branched part is outputted to the monitor 421, and the rest of the signal light is outputted to the optical coupler 412. The monitor 421 receives the signal light including signal channels λₛ₁-λ_{sM} branched by the optical coupler 411 to monitor the input power level of each signal channel.

The pumping light source 432 has the same structure as that of the pumping light source 132 in the first embodiment, and outputs forward pumping light including a pumping channel of wavelength λₚ₀ to the optical coupler 412. The optical coupler 412 outputs, to the Raman-amplifying optical fiber 410, the signal light including signal channels λₛ₁-λ_{sM} which has arrived from the optical coupler 411, and supplies the Raman-amplifying optical fiber 410 with the forward pumping light including pumping channel λₚ₀ output from the pumping light source 432.

The pumping light source 433 has the same structure as that of the pumping light source 133 in the first embodiment, and outputs backward pumping light multiplexed with N pumping channels of wavelengths λₚ₁-λ_{pN} (N is an integer greater than or equal to 2) to the optical coupler 413. The optical coupler 413 outputs, to the optical coupler 414, the signal light including signal channels λₛ₁-λ_{sM} which has arrived from the Raman-amplifying optical fiber 410, and supplies the Raman-amplifying optical fiber 410 with the backward pumping light including N pumping channels λₚ₁-λ_{pN} which has been output from the pumping light source 433.

The optical coupler 414 branches part of the signal light which has arrived from the optical coupler 413. The branched part is outputted to the monitor 422, and the rest of the signal light is outputted to the light output end 402. The monitor 422 receives the signal light including signal channels λₛ₁-λ_{sM} branched by the optical coupler 414 to monitor the output power level of each signal channel.

Here, the wavelength of each pumping channel included in the forward pumping light and the backward pumping light has the relationship expressed by the above formula (1). That is, the pumping channel λₚ₀ included in the forward pumping light has a wavelength less than or equal to the shortest wavelength of the N pumping channels λₚ₁-λ_{pN} which can be included in the backward pumping light.

Also, the power of the pumping light (including pumping channels of wavelengths λₚ₀-λ_{pN}) supplied from the pumping light sources 432 and 433 to the Raman-amplifying optical fiber 410, is arranged such that the effective length L_{eff} of the Raman-amplifying optical fiber 410 for the N pumping channels λₚ₁-λ_{pN} included in the backward pumping light is longer than the actual length L of the Raman-amplifying optical fiber 410.

The controller 440 performs feedforward control and/or feedback control based on the input power level of each signal channel monitored by the monitor 421 and the output power level of each signal channel monitored by the monitor 422.

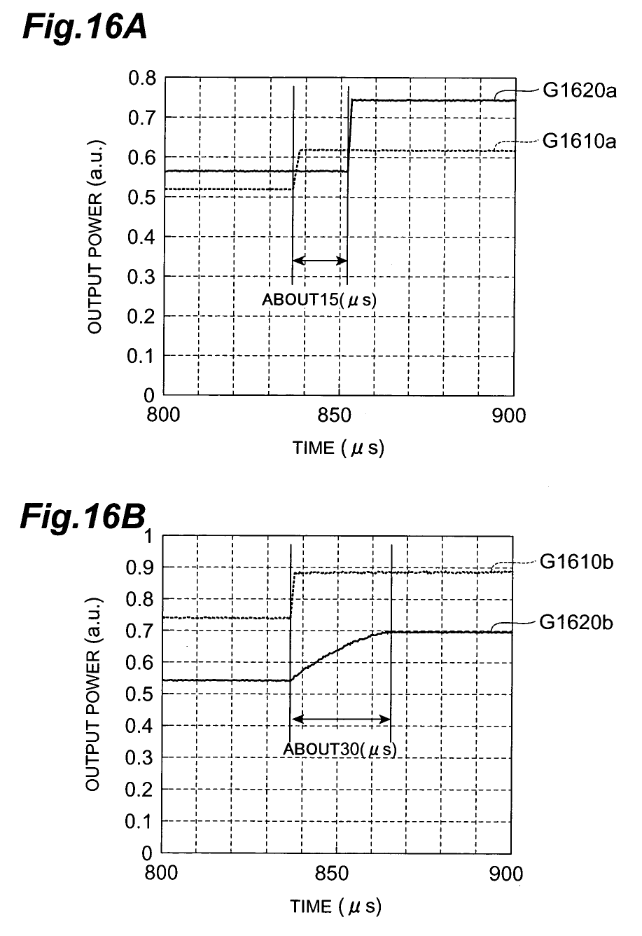

Here, in the widely used EDFA, by monitoring the input/output power of the signal light, and by performing power control of pumping light at a high speed, overshoot and undershoot of the transient response in the EDFA is suppressed. However, in Raman amplification, the time from a point when the output control of the pumping LD served as a pumping light source is carried out to a point when the control result thereof is reflected to the output of the signal light, as shown in FIGS. 16A and 16B, varies depending on fiber length and pumping direction of the Raman-amplifying optical fiber through which the signal light propagates. FIG. 16A is a graph showing the response of the output signal to the fluctuation of pumping light in forward pumping to the Raman-amplifying optical fiber of 3 km in length. FIG. 16B is a graph showing the response of the output signal to the fluctuation of pumping light in backward pumping to the Raman-amplifying optical fiber of 3 km in length. In FIGS. 16A and 16B, graphs G1610a and G1610b show temporal response of the power of pumping light, and graphs G1620a and G1620b show temporal response of the power of signal light. As demonstrated in FIG. 16A, in the case of forward pumping, a delay of approximately 15 μs corresponding to the length (3 km) of the Raman-amplifying optical fiber occurs from a point when the power fluctuation of the signal light is detected by the input monitor apparatus to a point when the same is detected by the output monitor apparatus. On the other hand, as shown in FIG. 16B, in the case of backward pumping, the output power fluctuation of the signal light responds taking RTT time for the effective length of the Raman-amplifying optical fiber, and delays approximately 30 us which is longer as compared to the case of the forward pumping.

To achieve the output control of the Raman amplifier precisely, the feedback control is indispensable. However, overshoot or undershoot of the transient response which is generated when the number of signal channels increases/decreases due to an OADM or the like, occurs during the delay time necessary for the output response of the signal light to the output fluctuation of the pumping light. Accordingly, to achieve a Raman amplifier suitable to a photonic network into which an OADM or OXC is introduced, the output control of 10 us order is necessary to suppress such overshoot and undershoot of the transient response. However, in the Raman amplifier, when an ordinary feedback control is made, which is faster than the response speed that depends on the fiber length and pumping direction of the Raman-amplifying optical fiber, the feedback is applied faster than the output response, thus theoretically resulting in oscillation of the output. Accordingly, in the fourth embodiment, two-step control is made, that is, a faster feedforward control is made to suppress the overshoot and undershoot of the transient response in the Raman amplifier, and a feedback control is made at a slower period to perform a precise output control.

The inventor prepared an experiment system, which has the same structure as the Raman amplifier shown in FIG. 15, and verified the effectiveness of the above-described two-step control method. That is, in this experiment system, setting the wavelength of the input signal channel to 1520 nm and 1525 nm, the response characteristic was verified when the signal channel of wavelength 1520 nm is left alive and the signal channels of wavelength 1525 nm is turned on and off.

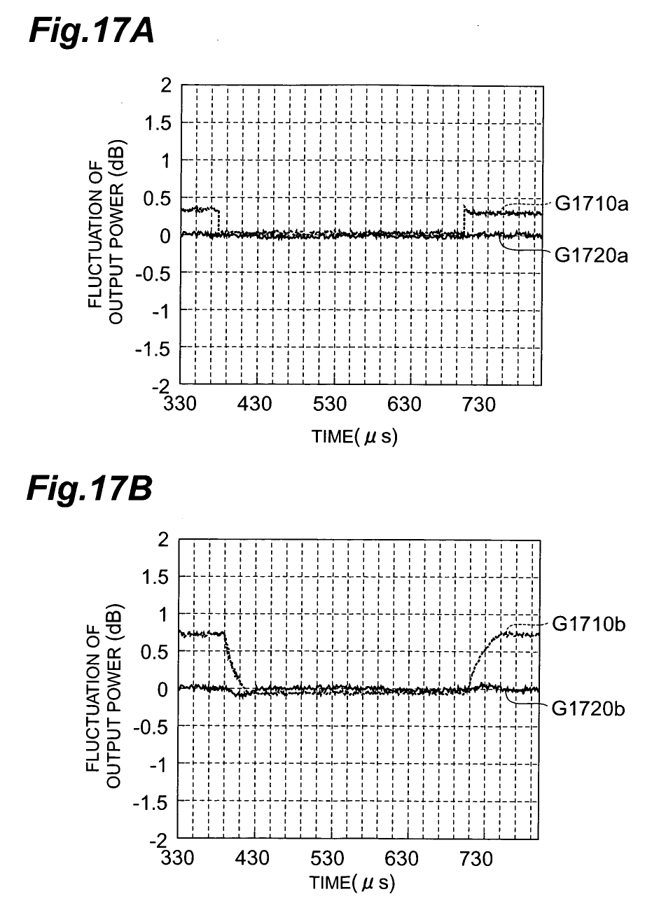

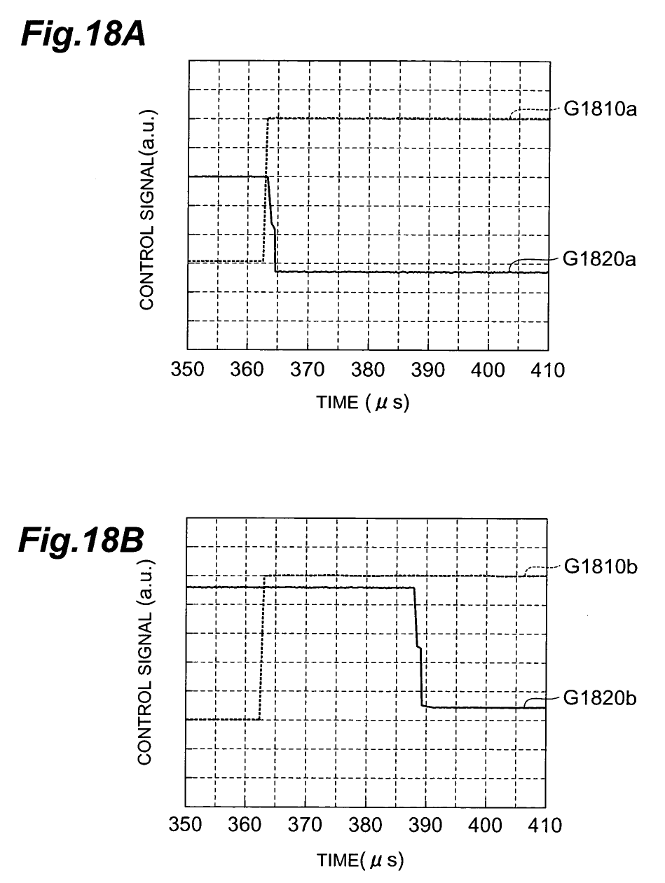

FIG. 17A shows the response characteristic in forward pumping. Graph G1710a shows the output power level of the signal light in a condition where the power control of the pumping light is not carried out. Graph G1720a shows the output power level of the signal light in a condition where the power control of the pumping light is carried out such that the output power level of the signal light is maintained constant. Further, FIG. 17B shows the response characteristic in backward pumping. Graph G1710b shows the output power level of the signal light in a condition where the power control of the pumping light is not carried out. Graph G1720b shows the output power level of the signal light in a condition where the power control of the pumping light is carried out such that the output power level of the signal light is maintained constant. As demonstrated in FIGS. 17A and 17B, when part of the signal channels is turned on and off in a condition where the power of pumping light is maintained constant (power control of the pumping light is not carried out), the response characteristic is such that, in the case of forward pumping (FIG. 17A), the output power level of the signal light changes in a stepwise manner, while in the case of backward pumping (FIG. 17B), the output power level of the signal light changes taking RTT time for the effective length of the Raman-amplifying optical fiber. Furthermore, FIG. 18A is a graph showing the temporal fluctuation of the signal light and the pumping light control signal at the transient response time in the case of forward pumping. FIG. 18B is a graph showing the temporal fluctuation of the signal light and the pumping light control signal at the transient response time in the case of backward pumping. In FIGS. 18A and 18B, graphs G1810a and G1810b show the temporal fluctuation of the signal light. Graphs 1820a and G1820b show the temporal fluctuation of the pumping light modulation.

As demonstrated in FIGS. 17A-18B, in the case of forward pumping, for the stepwise fluctuation of power of the signal light, by controlling the power of pumping light in a stepwise manner at the same time as the power fluctuation of the signal light, the output power level of the signal light is maintained constant. Also, it is understood that, in the case of backward pumping, for the stepwise fluctuation of power of the signal light, by controlling the power of pumping light in a stepwise manner at a timing that the power fluctuation of the signal light reaches the output end of the Raman-amplifying optical fiber (end of the fiber to which the backward pumping light is inputted), the output power level of the signal light can be controlled to be constant.

As described above, it is understood that the overshoot and undershoot of the transient response in the Raman amplifier 400 can be suppressed effectively by carrying out the following control. That is, at the time when power fluctuation of the signal light at the input end of the Raman-amplifying optical fiber 410 is detected by the monitor 421, the controller 440 performs feedforward control. On the other hand, at the time when power fluctuation of the signal light at the output end of the Raman-amplifying optical fiber 410 is detected by the monitor 422, the controller 440 performs feedforward control. Further, the output control can be carried out with higher precision by carrying out the feedback control in the following manner. That is, the controller 400 performs the feedback control on the pumping light sources 432 and 433 at a period slower than the time that is necessary for the signal light to propagate through the Raman-amplifying optical fiber 410 (propagation time).

In the fourth embodiment, at the time when power fluctuation of the signal light at the input end of the Raman-amplifying optical fiber 410 has been detected (detected by the monitor 421), the controller 440 may perform feedforward control on the pumping light source 433, and subsequently feedback control on the pumping light source 433 at a period slower than the time necessary for the signal light to propagate through the Raman-amplifying optical fiber 410. Also, at the time when power fluctuation of the signal light at the output end of the Raman-amplifying optical fiber 410 has been detected (detect by the monitor 422), the controller 440 may perform feedforward control on the pumping light source 432, and subsequently feedback control on the pumping light source 432 at a period slower than the time necessary for the signal light to propagate through the Raman-amplifying optical fiber 410. Further, at a point of time when power fluctuation of the signal light at the input end of the Raman-amplifying optical fiber 410 has been detected (detect by the monitor 421), the controller 440 may perform feedforward control on the pumping light source 432, and at a point of time when power fluctuation of the signal light at the output end of the Raman-amplifying optical fiber 410 has been detected (detected by the monitor 22), the controller 440 may perform feedforward control on the pumping light source 433, and subsequently feedback control on each of the pumping light sources 432 and 433 at a period slower than the time necessary for the signal light to propagate through the Raman-amplifying optical fiber 410. And, at a point of time when power fluctuation of the signal light at the input end of the Raman-amplifying optical fiber 410 has been detected (detected by the monitor 21), the controller 440 may perform feedforward control on the pumping light source 432, and subsequently feedback control on each of the pumping light sources 432 and 433 at a period slower than the time necessary for the signal light to propagate through the Raman-amplifying optical fiber 410. The Raman amplifier 400 structured as described above can easily improve the transient response characteristic without depending on the added/dropped signal channels.

The Raman amplifier that performs feedback control along with feedforward control as in the fourth embodiment may further comprise an optical transmission line (delay means), which is disposed between the input monitor apparatus and the input end of the Raman-amplifying optical fiber, and has a length such that the propagation time of the signal light corresponds to the time interval from a point of time when input power fluctuation is detected to a point of time when it is actually reflected to output power fluctuation.

(Fifth Embodiment of Raman Amplifier)

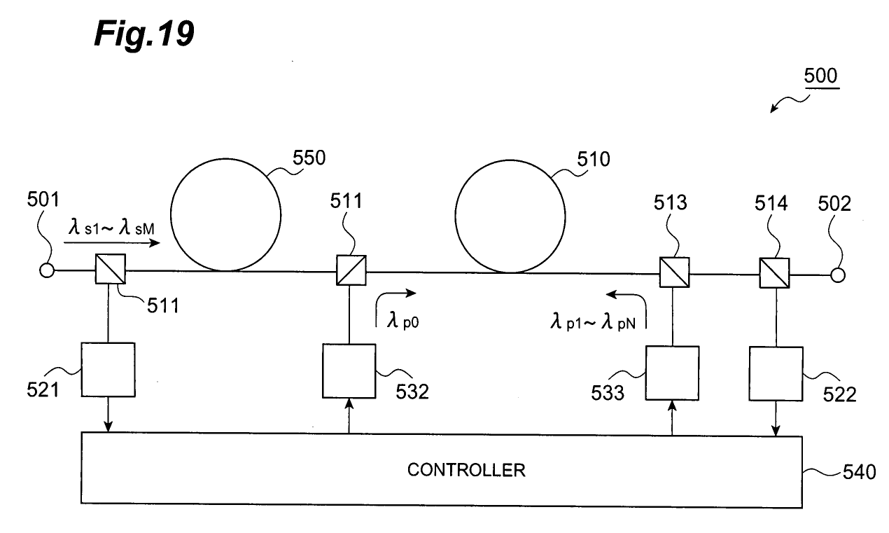

FIG. 19 is a diagram showing the configuration of a fifth embodiment of a Raman amplifier according to the present invention. The fifth embodiment has the same structure as the above-described fourth embodiment except a delay fiber disposed at the input end side of the Raman-amplifying optical fiber. That is, the Raman amplifier 500 shown in FIG. 19 comprises an optical coupler 211, a delay fiber (optical transmission line) 550, an optical coupler 512, a Raman-amplifying optical fiber 510, an optical coupler 513, and an optical coupler 514 being disposed in that order from a light input end 501 to a light output end 502. The Raman amplifier 500 further comprises a monitor 521 constituting part of an input monitor apparatus connected to the optical coupler 511, a pumping light source 532 (second pumping light source for supplying forward pumping light) connected to the optical coupler 512, a pumping light source 533 (first pumping light source for supplying backward pumping light) connected to the optical coupler 513, a monitor 522 constituting part of an output monitor apparatus connected to the optical coupler 514, and a controller 240. The controller 540 performs, as with the controller 440 in the fourth embodiment, feedforward control and feedback control on each of the pumping light source 532 and 533.

In the fifth embodiment structured as described above, the feedforward control carried out at the time when power fluctuation of the signal light is generated at the input end of the Raman-amplifying optical fiber 510 during forward pumping, is achieved in the following manner. That is, the delay fiber 550 shown in FIG. 19 is interposed between the optical coupler 512 (constituting part of the input monitor apparatus) and the Raman-amplifying optical fiber 510 to provide a delay time equivalent to the time from a point when the monitor 521 has detected the power fluctuation of the input signal light to the time when the output fluctuation of the pumping light is actually reflected to the Raman-amplifying optical fiber 510. On the other hand, in the feedforward control carried out at a point when power fluctuation of the signal light is generated at the output end of the Raman-amplifying optical fiber 510 during backward pumping, the timing of controlling the pumping light power can be controlled by using a delay circuit or the like for providing a delay time which depends on the fiber length of the Raman-amplifying optical fiber 510. The control amount of the pumping power in the feedforward control may be previously prepared as a table, or can be obtained by calculation.

The optical coupler 511 branches off part of signal light multiplexed with signal channels of wavelengths λₛ₁-λ_{sM} (M is an integer greater than or equal to 2) input through the light input end 501. The branched part is outputted to the monitor 521, and the rest of the signal light is outputted to the delay fiber 550. The monitor 521 receives the signal light including signal channels λₛ₁-λ_{sM} branched by the optical coupler 511 to monitor the input power level of each signal channel.

The delay fiber 550 is disposed between the optical coupler 511 and the optical coupler 512. The delay fiber 550 receives the signal light which has been output from the optical coupler 511, and transmits the signal light to the optical coupler 512.

The pumping light source 532 has the same structure as that of the pumping light source 132 in the first embodiment, and outputs forward pumping light including a pumping channel of wavelength λₚ₀ to the optical coupler 512. The optical coupler 512 outputs, to the Raman-amplifying optical fiber 510, the signal light including signal channels λₛ₁-λ_{sM} which has arrived from the delay fiber 550, and supplies the Raman-amplifying optical fiber 510 with the forward pumping light including pumping channel λₚ₀ which has been output from the pumping light source 532.

The pumping light source 533 has the same structure as that of the pumping light source 1.33 in the first embodiment, and outputs backward pumping light multiplexed with N pumping channels of wavelengths λₚ₁-λ_{pN} (N is an integer greater than or equal to 2) to the optical coupler 513. The optical coupler 513 outputs, to the optical coupler 514, the signal light including signal channels λₛ₁-λ_{sM} which has arrived from the Raman-amplifying optical fiber 510, and supplies the Raman-amplifying optical fiber 510 with the backward pumping light including N pumping channels λₚ₁-λ_{pN} which has been output from the pumping light source 533.

The optical coupler 511 branches part of the signal light which has arrived from the optical coupler 513. The branched part is outputted to the monitor 522, and the rest of the signal light is outputted to the light output end 502. The monitor 522 receives the signal light including signal channels λₛ₁-λ_{sM} branched by the optical coupler 513 to monitor the output power level of each signal channel.

Here, the wavelength of each pumping channel included in the forward pumping light and the backward pumping light has the relationship expressed by the above formula (1). That is, the pumping channel λₚ₀ included in the forward pumping light has a wavelength less than or equal to the shortest wavelength of the N pumping channels λₚ₁-λ_{pN} which can be included in the backward pumping light.

Also, the power of the pumping light (including pumping channels of wavelengths λₚ₀-λ_{pN}) supplied from the pumping light sources 532 and 533 to the Raman-amplifying optical fiber 510, is arranged such that the effective length L_{eff} of the Raman-amplifying optical fiber 510 for the N pumping channels λₚ₁-λ_{pN} included in the backward pumping light is longer than the actual length L of the Raman-amplifying optical fiber 510.

The controller 540 operates in the same manner as the controller 440 in the fourth embodiment. In particular, the Raman amplifier 500 in accordance with the fifth embodiment comprises the delay fiber 550 at the signal input end side of the Raman-amplifying optical fiber 510. The delay fiber 550 has a length such that the time necessary for the signal light to propagate through the delay fiber 550 is greater than or equal to the shortest time necessary for controlling the pumping light source 532 by the controller 540. By interposing the delay fiber 550 having a length as described above, the problem caused by the control delay, which is peculiar to the Raman amplifier, can be eliminated. Preferably, the controller 540 has also a function of adjusting the time necessary for controlling the pumping light source 532.

The delay fiber 550 may also be supplied with Raman-amplifying pumping light to Raman-amplify the signal light. To amplify the signal light, the delay fiber 550 may include an optical fiber doped with rare earth element. In these cases, the Raman amplifier 500 can achieve a high gain.

(Embodiment of Optical Communication System)

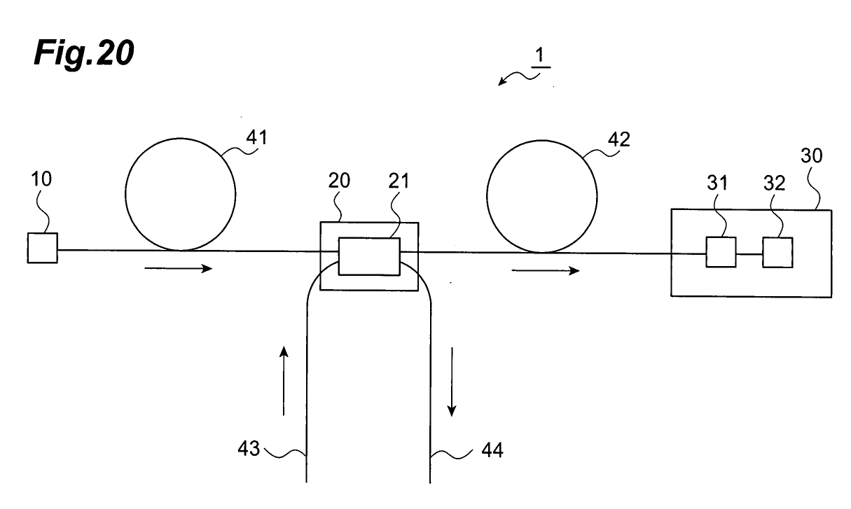

FIG. 20 is a diagram showing the configuration of one embodiment of an optical communication system according to the present invention. The optical communication system 1 shown in FIG. 20 comprises an optical transmission device 10, an optical relay device 20, an optical reception device 30 and optical fiber transmission lines 41-44. The optical relay device 20 includes an OADM 21. The optical reception device 30 includes a Raman amplifier 31 and a receiver 32. The Raman amplifier 31 has the same structure as that of any one of the Raman amplifiers 100, 200, 300, 400 and 500 in accordance with the above-described first to fifth embodiments.

The optical transmission device 10 multiplexes a plurality of signal channels of different wavelengths into signal light, and outputs the multiplexed light to the optical fiber transmission line 41. The OADM 21 within the optical relay device 20 receives the signal light which has propagated through the optical fiber transmission line 41, and outputs any of the signal channels included in the signal light to the optical fiber transmission line 44, and the rest of the signal channels to the optical fiber transmission line 42 along with the signal channels which have propagated through the optical fiber transmission line 43. The optical reception device 30 receives the signal light which has propagated through the optical fiber transmission line 42, and Raman-amplifies the input signal light with the Raman amplifier 31. The Raman-amplified signal light is received for each signal channel by the receiver 32.

In the optical communication system 1, the signal light which has propagated through the optical fiber transmission lines 41-43 and reached the optical reception device 30, is Raman-amplified by the Raman amplifier 31, and it can thus be received by the receiver 32 at a high sensitivity. Since the OADM 21 is provided within the optical relay device 20, the number of channels of the signal light reaching the optical reception device 30 may fluctuate. However, since the Raman amplifier 31 has the same structure as that of any of the Raman amplifiers 100-500 in accordance with the above-described first to fifth embodiments, the transient response characteristic in Raman amplification can be easily improved without depending on added/dropped signal channels. Accordingly, the quality of signal transmission of the optical communication system 1 achieves a satisfactory level.

As described above, in accordance with the present invention, the backward pumping light having a plurality of pumping channels is supplied to the Raman-amplifying optical fiber from the first pumping light source, and the forward pumping light is supplied from the second pumping light source. The wavelengths of the pumping channels included in the forward pumping light is arranged to be less than or equal to the shortest wavelength of the pumping channels included in the backward pumping light. The effective length of the Raman-amplifying optical fiber for each pumping channel of the backward pumping light is longer than the actual length thereof. The Raman amplifier structured as described above can easily improve the transient response characteristic without depending on the added/dropped signal channels.

As described above, the Raman amplifier, which has such structure that overshoot and undershoot of the transient response are effectively suppressed with ease without depending on the added/dropped signal channels, and enables output control with high precision, is applicable to a photonic network (a network in which the number of channels and the output fluctuate) in which an OAMD or OXC has been introduced as a key device.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A Raman amplifier, comprising:
a Raman-amplifying optical fiber having an input end into which signal light including a plurality of signal channels of different wavelengths is inputted and an output end from which the Raman-amplified signal light is outputted;
a first pumping light source for supplying backward pumping light including a plurality of pumping channels of different wavelengths into said Raman-amplifying optical fiber through the output end of said Raman-amplifying optical fiber; and
a second pumping light source for supplying forward pumping light including one or more pumping channels into said Raman-amplifying optical fiber through the input end of said Raman-amplifying optical fiber, the number of pumping channels in the forward pumping light being less than the number of pumping channels in said backward pumping light, and any pumping channel in the forward pumping light having a wavelength shorter than the shortest channel wavelength of the backward pumping light,
wherein the power of the backward pumping light and the power of the forward pumping light are arranged such that the effective length of said Raman-amplifying optical fiber for each pumping channel included in the backward pumping light becomes longer than the actual length of said Raman-amplifying optical fiber.

2. A Raman amplifier according to claim 1, further comprising:
an input monitor apparatus arranged at the input end side of said Raman-amplifying optical fiber for monitoring the input power level of each signal channel included in the signal light; and
a controller for controlling at least said second pumping light source based on the input power level of each signal channel included in the signal light monitored by said input monitor aparatus such that the output power level of each signal channel is set at a predetermined value.

3. A Raman amplifier according to claim 2, wherein, when the input power level of the signal channels has fluctuated in a predetermined pattern without change of the number of channels in the input signal light, said controller performs feedforward control only on the power of the backward pumping light supplied from said second pumping light source to said Raman-amplifying optical fiber.

4. A Raman amplifier according to claim 2, wherein, when the number of channels in the input signal light has changed, said controller performs feedforward control on the power of each of the pumping channels involved to Raman amplification of those signal channels whose input power level has not fluctuated exceeding a predetermined value.

5. A Raman amplifier according to claim 2, wherein, based on the input power level of the plurality of signal channels included in the signal light, said controller performs feedforward control on the power of the backward pumping light and the power of the forward pumping light such that the output power level of these signal channels is set at a predetermined value.

6. A Raman amplifier according to claim 2, wherein said controller adjusts the power of the backward pumping light and the power of the forward pumping light with respect to the Raman amplification characteristic of said Raman-amplifying optical fiber to set the Raman amplification gain in the case when the signal light is inputted into said Raman-amplifying optical fiber at 50% or more of the small signal gain itself.

7. A Raman amplifier according to claim 6, wherein the Raman amplification gain in the case when the signal light is inputted into said Raman-amplifying optical fiber is 80% or more of the small signal gain itself.

8. A Raman amplifier according to claim 5, wherein said controller adjusts the power of the backward pumping light and the power of the forward pumping light with respect to the Raman amplification characteristic of said Raman-amplifying optical fiber to set the Raman amplification gain in the case when the signal light is inputted into said Raman-amplifying optical fiber at 50% or more of the small signal gain itself.

9. A Raman amplifier according to claim 8, wherein the Raman amplification gain in the case when the signal light is inputted into said Raman-amplifying optical fiber is 80% or more of the small signal gain itself.

10. A Raman amplifier according to claim 2, further comprising:
an optical transmission line arranged between said input monitor apparatus and the input end of said Raman-amplifying optical fiber and having a length such that the propagation time of the signal light is greater than or equal to the shortest time necessary for controlling said second pumping light source by said controller.

11. A Raman amplifier according to claim 10, wherein said controller has a function of adjusting the time necessary for controlling said second pumping light source.

12. A Raman amplifier according to claim 10, wherein said optical transmission line serves as a transmission medium for Raman-amplifying the signal light.

13. A Raman amplifier according to claim 10, wherein said optical transmission line includes an optical fiber doped with a rare earth element.

14. A Raman amplifier according to claim 1, further comprising:
an input monitor apparatus arranged at the input end side of said Raman-amplifying optical fiber for monitoring the input power level of each signal channel included in the signal light; and
a dummy signal light supply system for supplying said Raman-amplifying optical fiber with dummy signal light having the same wavelength as the wavelength of the signal channel whose input power level monitored by said input monitor apparatus is less than or equal to a predetermined value.

15. A Raman amplifier according to claim 1, further comprising:
an input monitor apparatus arranged at the input end side of said Raman-amplifying optical fiber for monitoring the input power level of each signal channel included in the signal light;
an output monitor apparatus arranged at the output end side of said Raman-amplifying optical fiber for monitoring the output power level of each signal channel included in the Raman-amplified signal light; and
a controller for controlling said first and second pumping light sources based on the detection results obtained from said input monitor apparatus and said output monitor apparatus.

16. A Raman amplifier according to claim 15, wherein, at a point of time when the power fluctuation of the signal light at the input end of said Raman-amplifying optical fiber has been detected, said controller performs feedforward control on said first pumping light source, and subsequently feedback control on said first pumping light source at a period slower than the time necessary for the signal light to propagate through said Raman-amplifying optical fiber.

17. A Raman amplifier according to claim 16, further comprising:
an optical transmission line arranged between said input monitor apparatus and the input end of said Raman-amplifying optical fiber and having a length such that the propagation time of the signal light corresponds to the time interval from the time when input power fluctuation is detected to the time when the control for said first pumping light source is started.

18. A Raman amplifier according to claim 15, wherein, at the time when power fluctuation of the signal light at the output end of said Raman-amplifying optical fiber has been detected, said controller performs feedforward control on said second pumping light source, and subsequently feedback control on said second pumping light source at a period slower than the time necessary for the signal light to propagate through said Raman-amplifying optical fiber.

19. A Raman amplifier according to claim 15, wherein, at the time when power fluctuation of the signal light at the input end of said Raman-amplifying optical fiber has been detected, said controller performs feedforward control on said first pumping light source, and at the time when power fluctuation of the signal light at the output end of said Raman-amplifying optical fiber has been detected, said controller performs feedforward control on said second pumping light source, and subsequently said controller performs feedback control on each of said first and second pumping light sources at a period slower than the time necessary for the signal light to propagate through said Raman-amplifying optical fiber.

20. A Raman amplifier according to claim 15, wherein, at the time when power fluctuation of the signal light at the input end of said Raman-amplifying optical fiber has been detected, said controller performs feedforward control on said first pumping light source, and subsequently feedback control on each of said first and second pumping light sources at a period slower than the time necessary for the signal light to propagate through said Raman-amplifying optical fiber.

21. A Raman amplifier according to claim 20, further comprising:
an optical transmission line arranged between said input monitor apparatus and the input end of said Raman-amplifying optical fiber and having a length such that the propagation time of the signal light corresponds to the time interval from the time when input power fluctuation is detected to the time when the control for said first pumping light source is started.

22. An optical communication system including a Raman amplifier according to claim 1.
